(19) United States
(12) Patent Application Publication
(10) Pub. No.: US 2004/0177865 A1
(43) Pub. Date: Sep. 16, 2004

(54) Vehicle cleaning system

(76) Inventors: Chad A. Shero, Shakopee, MN (US); Robert A. Lindstrom, Shakopee, MN (US)

Correspondence Address: Kit M. Stetina, Esq., STETINA BRUNDA GARRED & BRUCKER, 75 Enterprise, Suite 250, Aliso Viejo, CA, 92656, US

(21) Appl. No.: 10/385,384

(22) Filed: Mar. 10, 2003

(51) Int. Cl. B08B 5/04

(52) U.S. Cl. 134/10; 134/18; 134/21

(57) ABSTRACT

An improved non-portable cleaning system for performing water-based extraction and related cleaning operations is provided. A system in accordance with the invention is particularly useful for cleaning the carpeting and upholstery of vehicle interiors and can be operated with relative ease by ordinary consumers. In certain implementations, the system can be coin operated. Defoamer chemical can be automatically dispersed into a recovery tank of the system, thereby reducing foaming in the recovery tank. The recovery tank can be automatically rinsed and drained after cleaning operations are completed without requiring additional interaction by the consumer. A vending machine can be optionally provided with the system, allowing consumers to purchase cleaning supplies incident to performing cleaning operations with the system.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to fabric cleaning systems, and more particularly to coin-operated non-portable water-based extraction systems which can be applied to cleaning the passenger compartment of a vehicle.

While various methods exist for cleaning automobile interiors, consumers are often faced with a number of unsatisfactory choices.

Professional automotive detail shops offer a variety of cleaning methods, ranging from bucket and brush techniques to hot and cold water extraction. Unfortunately, such professional shops typically require a professionally trained operator to perform the cleaning. Such shops may also require consumers to schedule an appointment and thereby surrender their vehicle for a period of time. This inconvenience, coupled with relatively high costs make these professional services an unattractive option for many consumers.

Dri-foam shampooing systems are also available. Such systems are often preferred for cleaning cotton and wool-based fabrics. Unfortunately, vehicle interiors use synthetic fabrics. As such, dri-foam shampooing can be ill-suited for use on vehicle interiors. In addition, dri-foam shampooing systems typically agitate foam into fabric without rinsing. In effect, such systems may simply smear dirt and chemical into fabric, and may leave a vehicle interior damp. Residual cleaning chemicals remaining in the fabric can attract soil, thus allowing the vehicle interior to become easily re-soiled. In addition, solvent-based chemicals used in dri-foam shampooing may exhibit dangerous flash points rendering them undesirable for use by consumers.

Professional carpet and upholstery cleaning systems for performing hot water extraction are also available. Such systems are usually portable and can require two 15-amp circuits which an ordinary consumer may only be able to provide through the use of two power cords connected to separate circuits. A recovery tank in these systems receives the dirty water extracted from fabrics. To prevent excessive foaming in the recovery tank, a manually supplied defoamer chemical is typically used, thereby preventing the vacuum motors of such systems from digesting too much wet foam. In addition, many of these systems require the recovery tank to be manually emptied and rinsed on a periodic basis. Such inconveniences are undesirable for operators of such systems.

Smaller portable hot water extraction systems are also available for rent or purchase by consumers. Unfortunately, such systems often provide only minimal performance due to under-powered pumps and vacuums, as well as the use of high foaming chemicals that are neither application or fabric-specific. Such systems may also require the purchase of additional costly chemicals in order to perform cleaning operations. Such systems may also require consumers to perform periodic maintenance incident to using the systems. If consumers choose to rent a portable system, they may be inconvenienced by the effort required to obtain and then return the system after use. Clearly, these can be significant drawbacks for many consumers.

In view of these unsatisfactory choices, there is a need for a cost-effective, low-maintenance system for cleaning the interior of a vehicle which can be operated by ordinary consumers.

### BRIEF SUMMARY OF THE INVENTION

The present invention, roughly described, is directed to an improved vehicle interior cleaning system which can be operated with relative ease by an ordinary consumer. In one embodiment, the cleaning system is coin-operated. In another embodiment, defoamer chemical is automatically dispersed into a recovery tank of the system, thereby reducing foaming in the recovery tank without requiring interaction by a user.

In another embodiment, the recovery tank can be automatically rinsed and drained after cleaning operations are completed without requiring additional interaction by the user.

In yet another embodiment, a user-operable vending machine can be optionally provided with the system, allowing a user to purchase auxiliary and/or specialized cleaning supplies incident to performing cleaning operations with the system.

Other embodiments are also possible, as set forth in the present disclosure including the specification, drawings, claims, and abstract.

### BRIEF DESCRIPTION OF THE DRAWINGS

Features of the present invention will become more apparent upon reference to the drawings wherein:

FIG. 1 illustrates a cleaning system in accordance with an embodiment of the present invention.

FIG. 2 is a cross-sectional side view of a recovery tank used in a cleaning system in accordance with an embodiment of the present invention.

FIG. 3 is a plumbing diagram illustrating the basic plumbing for implementing a cleaning system in accordance with an embodiment of the present invention.

FIG. 4 is a flowchart illustrating steps performed by a cleaning system in response to user activation of the system in accordance with an embodiment of the present invention.

### DETAILED DESCRIPTION OF THE INVENTION

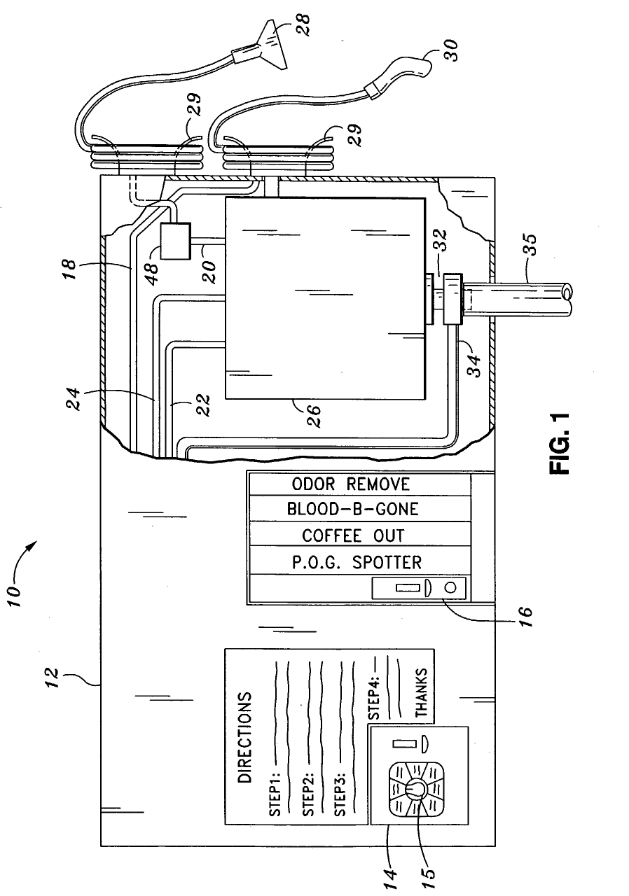

FIG. 1 illustrates an improved vehicle cleaning system 10 which can be used to perform water-based extraction and related operations for cleaning the passenger compartment (“interior”) of a vehicle. As a non-portable apparatus, system 10 can be permanently installed in a wall-mounted manner, pedestal-mounted manner, or island-mounted manner (such as in a detail center as part of an island package) at any convenient location which offers a local pressurized water supply, sewer access, and electrical power. For example, system 10 could be installed at any of the following locations: self-serve carwashes, convenience stores, gas and oil locations, quick lubes, truck stops, rest locations, auto enters, and camping & RV locations.

Electrical power (for example, 120 VAC power) for system 10 can be supplied in various ways known in the art. It will be understood that various numbers of dedicated and/or shared circuits can be used to power various components of system 10. For example, in one embodiment, various hard-wired dedicated circuits can be provided on the premises where the system is installed (such as from the location owner's breaker box). This power is received by an electronic control system (not shown) that is safe for wet environments. The control system transforms the power into appropriate low voltages used by various components of system 10, including water controlling and fluid management devices safe for wet locations. Power is also provided to a vacuum blower, heater, and other components used by system 10.

It is contemplated that appropriate voltages can be used for the various components of system 10 where desired. In addition, as referred to herein, “low voltage” denotes AC or DC voltages of approximately 12, 24, or 36 volts, or other voltages known in the art.

In one embodiment, system 10 is manufactured using removable component cavity shelving, thus simplifying the manufacturing process and reducing down-time of the system. Such an embodiment also facilitates off-location troubleshooting and simplicity in repairing the system for both warranty and non-warranty claims.

Referring to FIG. 1, system 10 includes a housing 12 which encloses various components of system 10 as further described herein. A meter 14 is attached to housing 12 for receiving money from a user in order to operate system 10. In various embodiments, meter 14 can be mechanically operated or electrically operated, and can receive coins, dollar bills, credit cards, vouchers, tokens, and/or other forms of payment. In one embodiment, a user can operate cleaning system 10 for a limited period of time after supplying sufficient payment to meter 14. Upon receiving sufficient payment, meter 14 triggers the control system to direct all functions of system 10.

A user-operable switch 15 is attached to housing 12 for selecting an operation to be performed by the cleaning system. By adjusting the orientation of switch 15, different operations can be performed as further described herein. In one embodiment, switch 15 is a mechanically-operated rotary switch exhibiting eight positions. In other embodiments, switch 15 can be implemented as a push button, sensor, toggle switch, rocker switch, or other controls known in the art.

A vending apparatus 16 can be optionally attached to the outside of housing 15. Vending apparatus 16 can provide stain/spot-specific cleaning supplies for purchase by a user. In one embodiment, the cleaning supplies are dispensed in individual containers, such as 2-oz bottles. A user can pre-treat soiled portions of a vehicle interior with these cleaning supplies before using system 10 to clean the area. For example, if a user wishes to pre-treat a coffee stain prior to cleaning a vehicle interior, the user could purchase a coffee-specific spot remover using vending apparatus 16. After applying the spot remover to the stained area, the user can spend further money to clean the area using cleaning system 10. To save electrical power, both meter 14 and vending apparatus 16 can be entirely and/or substantially mechanically operated.

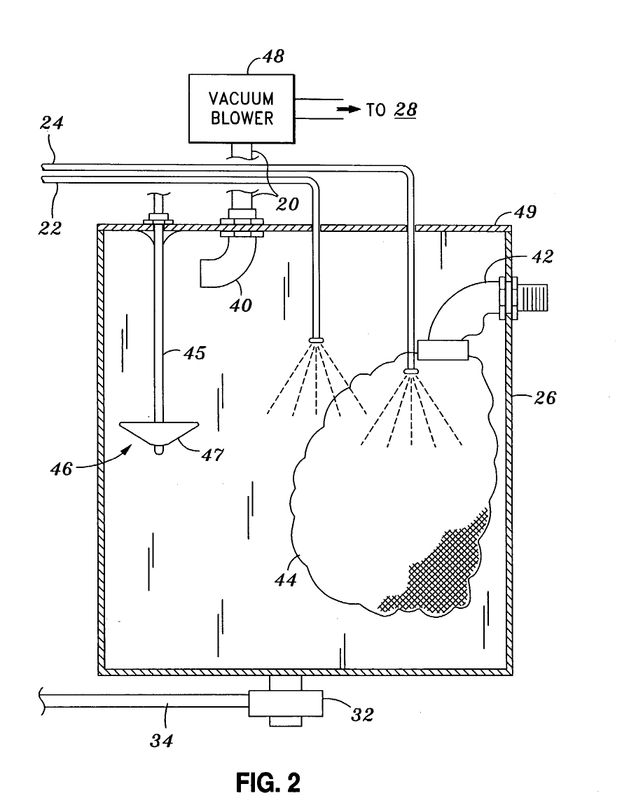

A vacuum blower 48 can be installed within housing 12. Vacuum blower 48 can be mounted above tank 26 and optionally connected to an optional drying tool 28 as illustrated in FIGS. 1 and 2. However, it will be appreciated that other configurations are also possible. The vacuum blower 48 can be implemented using various types of vacuum systems as known in the art.

System 10 also provides a recovery tank 26 for receiving waste solution retrieved by system 10. Vacuum line 20 is connected between vacuum blower 48 and tank 26 to provide vacuum suction to tank 26. User-operable cleaning tool 28 is attached to tank 26 through housing 12 and receives vacuum suction through tank 26. Cleaning tool 30 can be any appropriate cleaning tool known in the art. In various embodiments, cleaning tool 30 can utilize jetless trigerless technology (such as the DRIMASTER tool available from HYDRAMASTER Corporation), separate vacuum chambers (for example, dual chambers), the venturi principle, and/or other implementations known in the art.

Solution supply line 18 is connected to cleaning tool 30 to provide various cleaning solution mixtures from plumbing within housing 12 to cleaning tool 30. In embodiments where cleaning tool 30 utilizes jetless triggerless technology, a flow management apparatus (such as a needle valve) can be used (not shown) on solution line 18 within housing 12, allowing manual adjustment of the flow through line 18.

Cleaning tool 30 delivers cleaning solution to a surface selected by a user. Simultaneously, cleaning tool 30 vacuums waste solution and related waste products from the user-selected surface into tank 26, thereby completing an extraction process.

Optional drying tool 28 can be optionally connected to vacuum blower 48 through housing 12 to allow exhaust from the blower to dry surfaces which have been cleaned by cleaning tool 30.

Optional hose reels 29 can be affixed to housing 12 for storing tools 28 and 30 when not in use.

Rinse water supply line 22 provides pressurized water to tank 26 for rinsing the tank after user operation of system 10. Defoamer supply line 24 provides defoamer chemical periodically and/or continuously to tank 26 during user operation of system 10 in order to minimize foaming inside the tank, thus reducing the amount of foam carried through vacuum line 20 to vacuum blower 48.

It will be appreciated that lines 18, 20, 22, and 24 can be implemented as hoses, pipes, and/or other components as desired to implement aspects of the present invention.

A waterproof low voltage electronically-actuated valve 32 is attached to the bottom of tank 26 for draining recovered waste solution from the tank. Wiring 34 for valve 32 can be provided in any appropriate manner known in the art, and can optionally be enclosed by a conduit. When opened, valve 32 allows recovered waste solution to drain (as a result of gravity pressurization of tank 26) into local plumbing 35 for disposal of the waste solution. In various embodiments, valve 32 allows tank 26 to be drained into plumbing 35 having a diameter of approximately one and one half inches or larger. However, it will be appreciated that other diameters are also contemplated.

FIG. 2 is a cross-sectional side view of tank 26 of cleaning system 10. Vacuum nozzle 40 is attached to a lid 49 of tank 26 to receive vacuum suction from vacuum line 20 through a vacuum port opening in the lid 49. Waste intake nozzle 42 is attached to an interior wall of tank 26 to receive waste solution through a waste intake port opening in the wall. Vacuum suction introduced to tank 26 by vacuum blower 48 through vacuum line 20 allows waste solution to be vacuumed from cleaning tool 30 into the interior of tank 26. During user operation of system 10, the vacuum blower 48 runs continuously, thus drawing waste solution into tank 26 through waste intake nozzle 42.

Filter 44 is provided for filtering out waste material received with the vacuumed waste solution. In various embodiments, filter 44 can be implemented as a mesh sock, horizontal screen, cylindrical filler, drain filter, or other filters known in the art.

A high water auto-shutoff 46 is also provided and can be attached to the bottom, sides, or lid 49 of tank 26. Auto-shutoff 46 comprises a riser 45 and a float valve 47. As the waste solution level rises within the recovery tank, float valve 47 rises upwardly along riser 45. When float valve 47 reaches a prescribed vertical elevation, valve 32 is activated to drain tank 26, a service light (not shown) is activated, and system 10 shuts down. If tank 26 does not drain, the service light remains lit and system 10 remains shut down. If tank 26 does drain, then valve 32 closes, the service light is deactivated, and system 10 resumes normal operation.

Defoamer supply line 24 passes through lid 49 in tank 26 to automatically provide defoamer chemical to the interior of tank 26 without the need for a personal attendant. While the vacuum blower 48 is running, defoamer chemical is periodically and/or continuously injected into tank 26, thus reducing foaming caused by. aeration of any high foaming chemicals (previously applied by other systems) that are vacuumed into tank 26 with the waste solution. This reduces the amount of foam ingested by vacuum blower 48 through vacuum nozzle 40 and vacuum line 20, allowing longer life for the vacuum blower motors. The use of defoamer chemical also resists odor and debris build up in tank 26, and prevents excess foam from contacting electrical components of system 10.

Rinse water supply line 22 passes through lid 49 of tank 26 to provide rinse water to the interior of tank 26. After a timed cleaning operation cycle of system 10 is completed, rinse water supply line 22 provides clean rinse water to the interior of tank 26 to automatically rinse the tank after each use without the need for a personal attendant. In one embodiment, proper pressure and rinsing action is provided through the use of multiple jets (not shown) coupled to the end of supply line 22 inside tank 26. Simultaneously, valve 32 opens, thus allowing the rinse water and remaining waste solution to be automatically drained out of tank 26 without the need for a personal attendant.

Optionally, solution supply line 18 can pass through lid 49 and/or wall(s) of tank 26 (not shown) to help prevent against theft of cleaning tool 28.

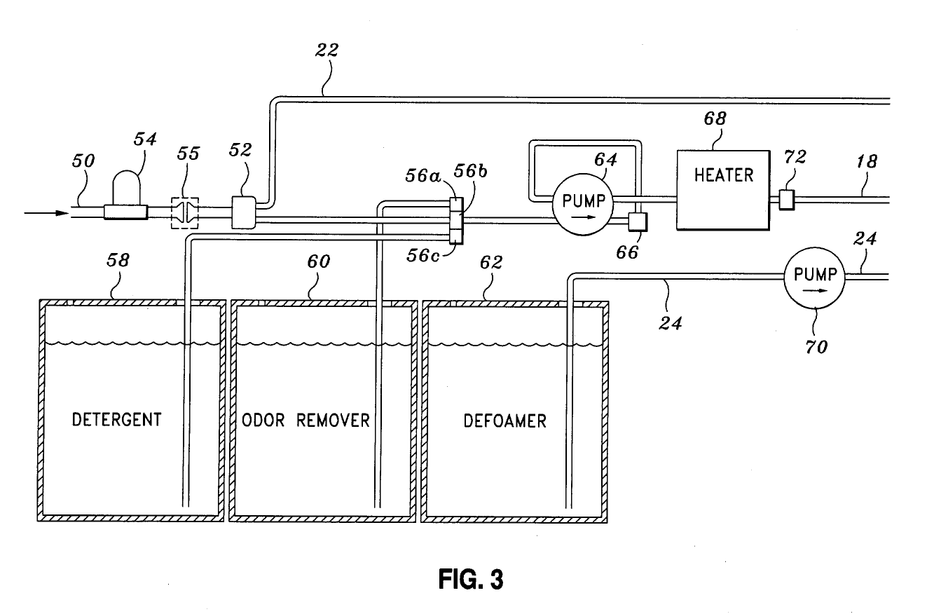

FIG. 3 illustrates the basic plumbing used to implement a cleaning system in accordance with an embodiment of the present invention. In one embodiment, substantially all of the components of FIG. 3 are located above tank 26, and reservoirs 58, 60, and 62 are located to the left of, and adjacent to, tank 26.

Local water supply line 50 provides pressurized water to system 10. In one embodiment, this water can be pressurized city water, thus precluding the need for a separate pump for rinse water supply line 22. In other embodiments, the water can be provided by a pump (not shown) fed by a reservoir or tank (not shown). For example, in certain embodiments where system 10 is island-mounted, reservoirs or tanks could be provided at the island.

The incoming water is received by pressure reducer 54. Pressure reducer 54 serves to reduce the effects of pressure variations in local water supply line 50, thus allowing consistent water pressure to be maintained downstream. It will be appreciated that pressure reducer 54 can be installed in other appropriate locations instead. For example, pressure reducer 54 could be installed downstream of union connector 55.

Incoming water passes through union connector 55 which facilitates the installation and removal of system 10 in embodiments implementing removable component cavity shelving. For example, supply line 50 and pressure reducer 54 could be permanently affixed at an installation location, while all components illustrated in FIG. 3 to the right of union connector 55 could be installed and/or removed together as a unit. An incoming water shutoff (not shown), such as a ball valve, can also be provided as appropriate to shut off incoming water

Low voltage electronically-actuated dual manifold valve 52 receives the incoming water from union connector 55. In one embodiment, valve 52 is implemented using brass. Valve 52 allows the incoming water to be routed to (1) rinse water supply line 22 in order to rinse tank 26; or (2) water passage 56b and downstream cleaning components.

Solution valves 56a and 56c receive odor remover chemical from reservoir 60 and detergent from reservoir 58, respectively.'Valves 56a and 56c can be implemented as low voltage electronically-actuated fixed-orifice two-way venturi valves, allowing metered amounts of odor remover chemical and detergent to be injected inline. Where valves 56a and 56c are implemented as venturi valves, bushings (not shown) in water passage 56b can be used to provide a proper amount of water in relation to the other metered chemicals.

Depending on the configuration of valves 56a and 56c, desired combinations of water, detergent, and odor remover chemical can be mixed together to provide an appropriate cleaning solution for the type of cleaning operation desired by a user. In various embodiments, different chemicals can be employed instead of the detergent and/or odor remover chemical. In an alternate embodiment, valves 56a and 56c can be positioned downstream of pump 64.

Switch 15 (illustrated in FIG. 1) is in communication with the control system (not shown). When a user changes the orientation of switch 15, the control system can actuate valves 56a and 56c to provide different cleaning solution mixtures.

It will be appreciated that additional chemical reservoirs and valves can be used in various embodiments, thus allowing additional numbers of chemicals to be injected. For example, by using ten valves and ten reservoirs, ten separate chemicals could be provided. It will also be appreciated that pumps, siphons, manually-operated apparatus, gravity-operated apparatus, venturi-operated apparatus, and/or other devices can be used in place of valves 56a and 56c (or additional valves) to perform inline injection.

Low voltage electric pump 64 receives the cleaning solution mixture from components 56a-c and provides pressure to propel the solution to other downstream components. Pressure relief valve 66 can be optionally provided.

Heater 68 heats the cleaning solution received from pump 64 before outputting heated cleaning solution to downstream valve 72. In various embodiments, heater 68 can be a conventional heater hardwired using two circuits, each circuit providing 120 VAC, 240 VAC, or other voltages. An optional heating device (not shown) can also be installed in system 10 to heat the cleaning solution.

An optional normally-closed low voltage electronically-actuated trapping valve 72 operates in conjunction with valve 52 to create a trap between valve 52 and trapping valve 72. The presence of cleaning solution in this trap allows heater 68 to be operated continuously (i.e. 24 hours per day), regulating itself. As a result, pre-heated cleaning solution residing in the trap can be available for use as soon as the cleaning system is activated by a user.

Electric pump 70 operates periodically and/or continuously to provide pressure for propelling defoamer chemical from defoamer reservoir 62 through defoamer supply line 24 to tank 26 while the vacuum blower 48 is operating. This allows defoamer chemical to be periodically and/or continuously pumped into tank 26 during operation of the cleaning system, thus reducing the tendency of waste solution to foam excessively in tank 26. The defoamer chemical is measured and precisely injected into tank 26 using flow management to achieve proper dilution ratios. In various embodiments, pump 70 is a low flow, low psi, self-priming pump which can be external to, or submersed in (not shown), defoamer reservoir 62. In alternate embodiments, a siphon, gravity-operated apparatus, and/or other devices can be used in place of pump 70.

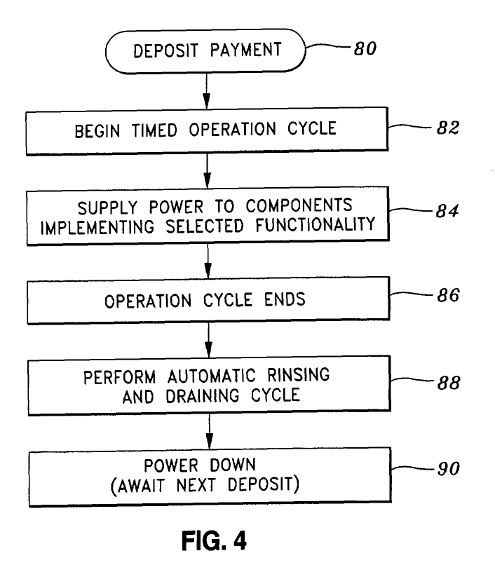

FIG. 4 is a flowchart illustrating steps performed by cleaning system 10 in response to user activation of the system. Beginning at step 80, user payment (i.e. coins, dollar bills, credit cards, vouchers, tokens, and/or other forms of payment) is received by meter 14. In response to the receipt of payment, a timed cleaning operation cycle is started through the use of a control system (step 82). For example, a five minute cycle could be started when $3.00 is deposited into meter 14.

As discussed above, a control system can be provide d for transforming electrical power. The control system can also be used to implement all timed operations of system 10. All electronic components of system 10 can be activated and deactivated by the control system to implement the functionality described herein.

At step 84, power is supplied to appropriate components of system 10 which implement the cleaning operations corresponding to the position of switch 15. At each switch position, an appropriate set of components is activated, allowing a user to achieve the functionality indicated by switch 15. It will be appreciated that a variety of cleaning operations can be provided by system 10. Accordingly, the cleaning operations explained below are for purposes of example, and are not intended to be an exhaustive list of all possible operations.

The following Table 1 illustrates a sample list of cleaning operations which can be performed in accordance with different settings of switch 15:

TABLE 1

| Switch Setting | Operation Performed |
|---|---|
| Vac Only | Vacuum surface |
| Clean Rinse | Clean surface using water only |
| Shampoo | Clean surface using detergent only |
| Shampoo Plus | Clean surface using detergent and |
| | odor remover chemical only |
| | (recommended) |
| Odor Remover | Clean surface using odor remover |
| | chemical only |
| Dryer | Dry surface using drying tool |
| Expansion | Future functionality |
| Off | No operation |

Vac Only Settinq: When switch 15 is set to “Vac Only,” power is applied to the vacuum blower 48. This setting allows a user to vacuum a vehicle interior using cleaning tool 30. Waste material collected by cleaning tool 30 is vacuumed through waste intake nozzle 42 into tank 26 where it can be trapped by filter 44. Simultaneously, defoamer pump 70 provides defoamer chemical periodically and/or continuously to tank 26 for reducing foam in the tank.

Clean Rinse Setting: When switch 15 is set to “Clean Rinse,” power is applied to the vacuum blower 48, valve 52 (the lower port feeding water passage 56b is opened; the upper port feeding rinse water supply line 22 remains closed), pump 64, trapping valve 72, and pump 70. This setting allows a user to clean a vehicle interior using water only. A cleaning solution of only water is pumped through heater 68 and trapping valve 72 into cleaning tool 30. Waste solution is extracted back through tool 30 and collected in tank 26. Simultaneously, defoamer pump 70 provides defoamer chemical periodically and/or continuously to tank 26 for reducing foam in the tank.

Shampoo Setting: When switch 15 is set to “Shampoo,” power is applied as in the “Clean Rinse” setting, but valve 56c is also opened. This allows a cleaning solution of detergent and water to be provided.

Shampoo Plus Settinq: When switch 15 is set to “Shampoo Plus,” power is applied as in the “Shampoo” setting, but both of valves 56a and 56c are opened. This allows a cleaning solution of detergent, odor remover chemical, and water to be provided.

Odor Remover Setting: When switch 15 is set to “Odor Remover,” power is applied as in the “Clean Rinse” setting, but valve 56a is also opened. This allows a cleaning solution of odor remover chemical and water to be provided.

Dryer Setting: When switch 15 is set to “Dryer,” power is applied to the vacuum blower 48. This setting allows a user to dry a vehicle interior using optional drying tool 28.

Expansion Setting: When switch 15 is set to “Expansion,” power is applied in accordance with an operation to be implemented in the future.

Off Setting: When switch 15 is set to “Off,” no power is applied and no cleaning operation is performed.

At all settings of switch 15, power continues to be supplied to heater 68 in order to preheat cleaning solution for future use.

Referring again to FIG. 4, at step 86 the timed cycle initiated in step 82 ends. As a result, power for the vacuum blower 48, trapping valve 72, as well as components 56a, 56c, 64, and 70 is turned off.

At step 88, an automatic rinsing and draining cycle is performed. During this step, all settings of switch 15 are null and void. The upper port of valve 52 is opened to feed rinse water supply line 22 (the lower port feeding water passage 56b is closed) to rinse tank 26. Valve 32 is also opened, allowing waste solution collected in tank 26 to drain into local plumbing 35.

These valve settings are maintained for a fixed period of time (i.e. fifteen seconds) during step 88, allowing the automatic cycle to complete. After the time period has expired, system 10 powers down and awaits the next deposit (step 90), wherein the steps of FIG. 4 can be repeated.

While illustrative embodiments of the present invention have been described above, it will be understood that such embodiments have been provided for the purposes of disclosure and not limitation. The inventive concepts set forth herein may be otherwise variously embodied and employed. For example, it will be appreciated that where applicable, hoses, pipes, conduits, and other types of fluid lines can be used interchangeably to implement components of the present invention. Moreover, the appended claims are intended to be construed to include such variations except insofar as limited by prior art.

What is claimed is:

1. A non-portable system for cleaning a vehicle interior comprising:
a recovery tank;
a user-operable cleaning tool attached to said recovery tank;
a solution supply line in fluid communication with said cleaning tool for providing a cleaning solution to said cleaning tool;
a vacuum blower in vacuum communication with said recovery tank and said cleaning tool, said vacuum blower capable of introducing vacuum suction to said recovery tank and said cleaning tool; and
a defoamer supply line in fluid communication with said recovery tank, said defoamer supply line capable of automatically dispersing defoamer chemical into said recovery tank during operation of said vacuum blower.

2. The cleaning system of claim 1, further comprising:
a plurality of electronically-actuated solution valves in fluid communication with said solution supply line; and
a plurality of fluid supply lines in fluid communication with said solution valves, said solution valves capable of selectively passing fluid from said supply lines to provide at least a portion of said cleaning solution.

3. The cleaning system of claim 2, further comprising:
a control system in electrical communication with said solution valves;
a user-operable switch in electrical communication with said control system, wherein a mixture of said cleaning solution is determined by a user-selected orientation of said switch.

4. The cleaning system of claim 1, further comprising:
a housing enclosing a least a portion of said cleaning system.

5. The cleaning system of claim 4, further comprising:
a control system;
a coin meter attached to said housing, said coin meter capable of triggering said control system in response to payment deposited by a user into said coin meter.

6. The cleaning system of claim 4, further comprising:
a user-operable vending machine attached to said housing, said vending machine providing a plurality of cleaning supplies for purchase by a user.

7. The cleaning system of claim 4, further comprising:
a reel affixed to said housing for storing said cleaning tool.

8. The cleaning system of claim 1, further comprising:
a heater positioned upstream of said cleaning tool in fluid communication with said solution supply line, said heater capable of pre-heating said cleaning solution before said solution is provided to said cleaning tool.

9. The cleaning system of claim 1, further comprising:
an electronically-actuated water valve in fluid communication with a local water supply;
a rinse water supply line in fluid communication with said water valve and said recovery tank, wherein said rinse water is dispersed to an interior of said recovery tank upon opening of said water valve;
a waste drainage port opening said recovery tank;
an electronically-actuated drainage valve attached to said drainage port, wherein waste solution is drained from said interior of said recovery tank by gravity upon opening of said drainage valve; and
a control system in electrical communication with said water and drainage valves for automatically opening and closing said water and drainage valves.

10. A recovery tank for use with a non-portable system for cleaning a vehicle interior comprising:
an enclosure for holding recovered waste solution;
a waste intake port opening in said enclosure, said intake port capable of receiving waste solution into an interior of said enclosure;
a vacuum port opening in said enclosure, said vacuum port capable of receiving vacuum suction introduced from an exterior of said enclosure;
a waste drainage port opening in said enclosure, said drainage port capable of draining said waste solution out of said interior of said enclosure by gravity;
an electronically-actuated drainage valve attached to said drainage port;
a defoamer port opening in said enclosure, said defoamer port capable of receiving defoamer chemical into said interior of said enclosure; and
a water rinse port opening in said enclosure, said rinse port capable of receiving rinse water into said interior of said enclosure.

11. The recovery tank of claim 10, further comprising:
a defoamer supply line attached to said defoamer port, said defoamer supply line capable of dispersing defoamer chemical into a substantial portion of said interior of said enclosure.

12. The recovery tank of claim 10, further comprising:
a rinse water supply line attached to said water rinse port, said rinse water supply line capable of dispersing water into a substantial portion of said interior of said enclosure.

13. The recovery tank of claim 10, further comprising:
a waste intake nozzle attached to said waste intake port; and
a filter attached to said waste intake nozzle, said filter capable of filtering waste material received with said waste solution.

14. The recovery tank of claim 10, further comprising:
a vacuum nozzle attached to an interior wall of said enclosure, said vacuum nozzle in vacuum communication with said vacuum port.

15. The recovery tank of claim 10, further comprising:
a high water auto-shutoff apparatus attached to an interior wall of said enclosure.

16. A method for maintaining a non-portable system for cleaning a vehicle interior comprising:
vacuuming waste solution into a recovery tank for a time period;
automatically providing defoamer chemical to said recovery tank during said vacuuming step;
automatically rinsing said recovery tank after expiration of said time period; and
automatically draining said recovery tank during said rinsing step.

17. The method of claim 16, wherein said providing step comprises:
pumping said defoamer into said recovery tank using an electric pump.

18. The method of claim 16, wherein said automatic rinsing and draining steps are initiated by operating electronically-actuated valves.

19. The method of claim 16, wherein said vacuuming step comprises:
applying vacuum suction to a port of said recovery tank.

20. The method of claim 16, further comprising:
filtering waste material received with said waste solution during said vacuuming step.

21. A non-portable system for cleaning a vehicle interior comprising:
a recovery tank;
a user-operable cleaning tool attached to said recovery tank;
a solution supply line in fluid communication with said cleaning tool for providing a cleaning solution to said cleaning tool;
a vacuum blower in vacuum communication with said recovery tank and said cleaning tool, said vacuum blower capable of introducing vacuum suction to said recovery tank and said cleaning tool; and
a coin-operated controller for activating said system.

22. The cleaning system of claim 21, further comprising:
a defoamer supply line in fluid communication with said recovery tank, said defoamer supply line capable of automatically dispersing defoamer chemical into said recovery tank during operation of said vacuum blower.

23. The cleaning system of claim 22, further comprising:
an electronically-actuated water valve in fluid communication with a local water supply;
a rinse water supply line in fluid communication with said water valve and said recovery tank, wherein said rinse water is dispersed to an interior of said recovery tank upon opening of said water valve;
a waste drainage port opening said recovery tank;
an electronically-actuated drainage valve attached to said drainage port, wherein waste solution is drained from said interior of said recovery tank by gravity upon opening of said drainage valve; and
a control system in electrical communication with said water and drainage valves for automatically opening and closing said water and drainage valves.
